(19) United States
(12) Patent Application Publication
(10) Pub. No.: US 2024/0311655 A1
(43) Pub. Date: Sep. 19, 2024

(54) TOPOLOGY EXPLORER FOR MESSAGE-ORIENTED MIDDLEWARE USING MACHINE LEARNING TECHNIQUES

(71) Applicant: Dell Products L.P., Round Rock, TX (US)

(72) Inventors: Shashikiran Rajagopal, Bengaluru (IN); Alla Bharath, Andhra Pradesh (IN); G. Madhanmohan Reddy, Andrapradesh (IN); Krishna Mohan Akkinapalli, Leander, TX (US); Bijan Kumar Mohanty, Austin, TX (US); Hung T. Dinh, Austin, TX (US); Satish Ranjan Das, Round Rock, TX (US)

(21) Appl. No.: 18/121,252

(22) Filed: Mar. 14, 2023

(51) Int. Cl. G06N 5/022

(52) U.S. Cl. CPC G06N 5/022

(57) ABSTRACT

Methods, apparatus, and processor-readable storage media for implementing topology explorers for message-oriented middleware using machine learning techniques are provided herein. An example computer-implemented method includes obtaining data pertaining to at least one messaging topology associated with at least one message-oriented middleware; predicting one or more anomalies associated with the at least one messaging topology by processing at least a portion of the obtained data using a first set of one or more machine learning techniques; recommending one or more alternate messaging topologies associated with the at least one message-oriented middleware by processing at least a portion of the one or more predicted anomalies and at least a portion of the obtained data using a second set of one or more machine learning techniques; and performing one or more automated actions based on the one or more predicted anomalies and/or the one or more recommended alternate messaging topologies.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to techniques for data processing in such systems.

### BACKGROUND

Message-oriented middleware (also referred to herein as “MOM”) allows distributed applications to communicate and exchange data by sending and receiving messages. However, different systems can provide different libraries and user interfaces to display various topologies between source and target applications with different parameters. Such heterogenous source and target applications are not consistent across message-oriented middleware platforms, which adds to the complexity associated with interfacing actions. Additionally, conventional message-oriented middleware management techniques are commonly reactive in nature and require specific system knowledge, often resulting in resource-intensive outages and delays in connection with various data processing tasks.

### SUMMARY

Illustrative embodiments of the disclosure provide topology explorers for message-oriented middleware using machine learning techniques.

An exemplary computer-implemented method includes obtaining data pertaining to at least one messaging topology associated with at least one message-oriented middleware, and predicting one or more anomalies associated with the at least one messaging topology by processing at least a portion of the obtained data using a first set of one or more machine learning techniques. The method also includes recommending one or more alternate messaging topologies associated with the at least one message-oriented middleware by processing at least a portion of the one or more predicted anomalies and at least a portion of the obtained data using a second set of one or more machine learning techniques. Additionally, the method includes performing one or more automated actions based at least in part on one or more of the one or more predicted anomalies and the one or more recommended alternate messaging topologies.

Illustrative embodiments can provide significant advantages relative to conventional message-oriented middleware management techniques. For example, problems associated with resource-intensive outages and delays are overcome in one or more embodiments through exploring and processing message-oriented middleware messaging topologies using machine learning techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for implementing topology explorers for message-oriented middleware using machine learning techniques in an illustrative embodiment.

FIG. 2 shows example message-oriented middleware topology explorer architecture in an illustrative embodiment.

FIG. 3 shows example message-oriented middleware topology explorer architecture in an illustrative embodiment.

FIG. 4 shows example pseudocode for data acquisition in an illustrative embodiment.

FIG. 5 shows example pseudocode for metadata classification in an illustrative embodiment.

FIG. 6 shows example pseudocode for intelligent mapping techniques in an illustrative embodiment.

FIG. 7 shows example messaging topology anomaly prediction engine architecture in an illustrative embodiment.

FIG. 8 shows example pseudocode for importing libraries in an illustrative embodiment.

FIG. 9 shows example pseudocode for loading messaging topology metrics data in an illustrative embodiment.

FIG. 10 shows example pseudocode for instantiating an isolation forest model in an illustrative embodiment.

FIG. 11 shows example pseudocode for determining an anomaly score in an illustrative embodiment.

FIG. 12 shows an example flow diagram for model training and testing in an illustrative embodiment.

FIG. 13 shows an example random forest classifier structure in an illustrative embodiment.

FIG. 14 shows messaging topology recommendation engine architecture in an illustrative embodiment.

FIG. 15 shows example pseudocode for importing libraries and one or more filters in an illustrative embodiment.

FIG. 16 shows example pseudocode for reading a data file and splitting datasets in an illustrative embodiment.

FIG. 17 shows example pseudocode for training and testing a random forest classifier in an illustrative embodiment.

FIG. 18 is a flow diagram of a process for implementing topology explorers for message-oriented middleware using machine learning techniques in an illustrative embodiment.

FIGS. 19 and 20 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

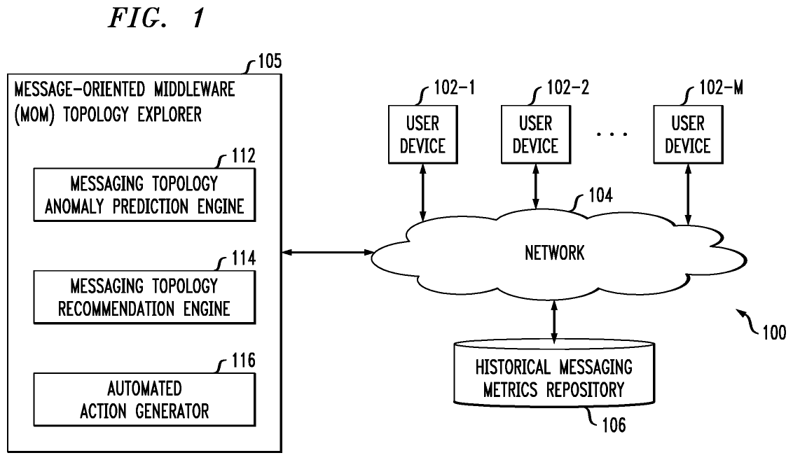

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is message-oriented middleware topology explorer 105 (also referred to herein and in the Figures as “MOM topology explorer”).

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, MOM topology explorer 105 can have an associated historical messaging metrics repository 106 configured to store data pertaining to normal situations and outage situations, which comprise, for example, queue depth, number of producers and consumers, messages ready, messages unacknowledged, input-output (IO) utilization, etc.

The historical messaging metrics repository 106 in the present embodiment is implemented using one or more storage systems associated with MOM topology explorer 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with MOM topology explorer 105 are one or more input-output devices, which illustratively comprise keyboards, displays or other types of input-output devices in any combination. Such input-output devices can be used, for example, to support one or more user interfaces to MOM topology explorer 105, as well as to support communication between MOM topology explorer 105 and other related systems and devices not explicitly shown.

Additionally, MOM topology explorer 105 in the FIG. 1 embodiment is assumed to be implemented using at least one processing device. Each such processing device generally comprises at least one processor and an associated memory, and implements one or more functional modules for controlling certain features of MOM topology explorer 105.

More particularly, MOM topology explorer 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows MOM topology explorer 105 to communicate over the network 104 with the user devices 102, and illustratively comprises one or more conventional transceivers.

The MOM topology explorer 105 further comprises messaging topology anomaly prediction engine 112, messaging topology recommendation engine 114, and automated action generator 116.

It is to be appreciated that this particular arrangement of elements 112, 114 and 116 illustrated in the MOM topology explorer 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for implementing topology explorers for message-oriented middleware using machine learning techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, MOM topology explorer 105 and historical messaging metrics repository 106 can be on and/or part of the same processing platform.

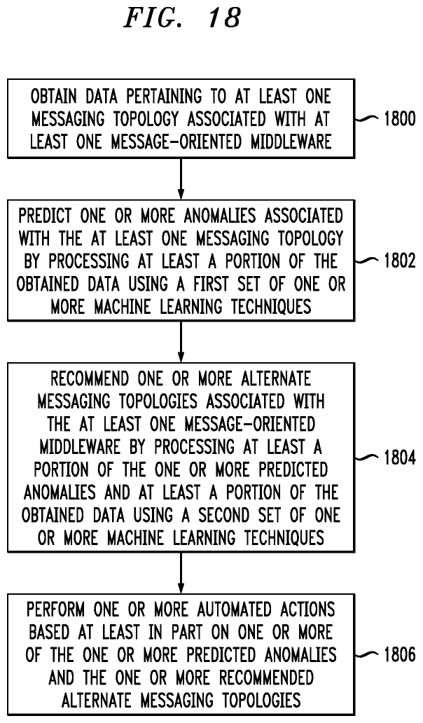

An exemplary process utilizing elements 112, 114 and 116 of an example MOM topology explorer 105 in computer network 100 will be described in more detail with reference to the flow diagram of FIG. 18.

Accordingly, at least one embodiment includes topology explorers for message-oriented middleware using machine learning techniques. Specifically, such an embodiment includes generating and/or implementing at least one topology explorer for message-oriented middleware to view one or more routing messaging patterns being used by a given message-oriented middleware ecosystem, to examine the current status of one or more integrations, and to predict one or more message failures using machine learning techniques and/or anomaly detection techniques. As used herein, a messaging topology (also referred to as a message-oriented middleware topology) refers to a set of one or more hubs, associated with at least one message-oriented middleware, between one or more sources and one or more targets. Additionally or alternatively, one or more embodiments include using at least one machine learning-based classification model to recommend at least one messaging pattern (e.g., the optimal messaging pattern) for improved handling and self-healing.

As noted above and herein, various topologies can be associated with different message-oriented middleware producers and consumer end-to-end (E2E) flows. By way merely of example, such topologies can include a peer-to-peer (P2P) topology without routing and based on one or more key values, a P2P topology without routing and with load balancing (LB) in a round-robin fashion, a P2P topology without routing at a first hub then a many-to-one implementation on a second hub, a P2P topology with routing and based on different routing key values (e.g., R1, R2, R3) for each downstream hub, a fanout exchange which routes messages to all of the queues that are bound thereto, and a pub/sub model wherein any message published to a topic is immediately received by all subscribers to the topic.

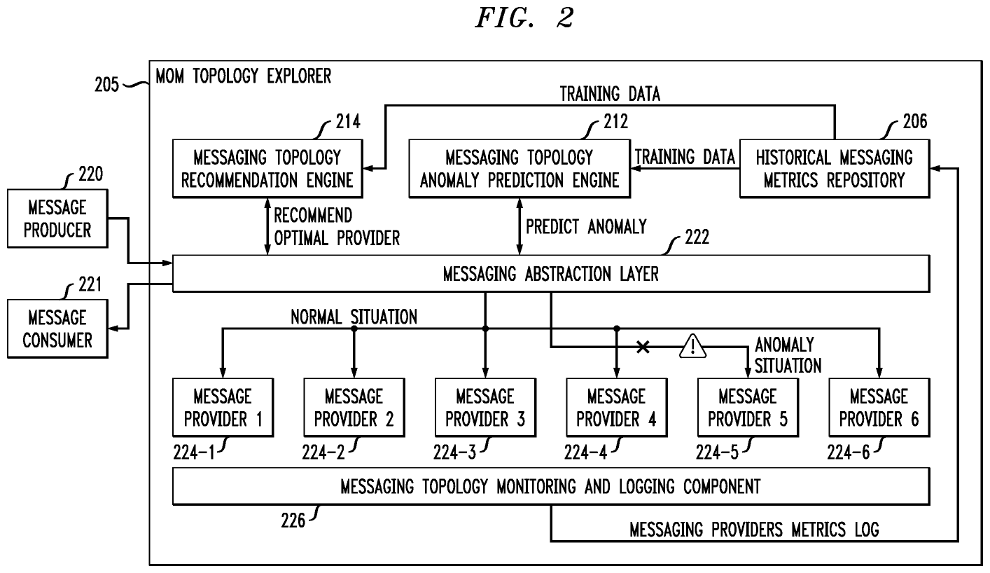

As further detailed herein, at least one embodiment includes generating and/or implementing a messaging framework to provide at least one real-time relationship user interface (UI) between source and target applications in a distributed environment for multiple message-oriented middleware topologies. Such an embodiment also includes predicting (preemptively) one or more failures in messaging systems and identifying one or more message-oriented middleware topologies for handling and processing tasks. As additionally illustrated and described herein (e.g., in connection with FIG. 1 and FIG. 2), such capabilities can be achieved by implementing a message-oriented middleware topology explorer, which can include a messaging topology anomaly prediction engine and a messaging topology recommendation engine.

FIG. 2 shows example MOM topology explorer architecture in an illustrative embodiment. By way of illustration, FIG. 2 depicts MOM topology explorer 205, as well as message producer 220 and message consumer 221. In the example embodiment depicted in FIG. 2, MOM topology explorer 205 includes messaging topology recommendation engine 214, messaging topology anomaly prediction engine 212, historical messaging metrics repository 206, messaging abstraction layer 222, messaging topology monitoring and logging component 226, message providers 224-1, 224-2, 224-3, 224-4, 224-5 and 224-6 (collectively referred to herein as message providers 224).

More specifically, FIG. 2 depicts MOM topology explorer 205 obtaining one or more messages from message producer 220. Also, messaging abstraction layer 222 abstracts one or more application programming interface (API) calls from message producer 220 to message consumer 221. Additionally, messaging abstraction layer 222, based at least in part on such action(s), provides inputs to messaging topology recommendation engine 214 and messaging topology anomaly prediction engine 212. Messaging topology anomaly prediction engine 212, trained using data from historical message metrics repository 206 (which obtains data (e.g., messaging provider metrics log data) from messaging topology monitoring and logging component 226), predicts one or more anomalies related to the message content, and provides such predictions to messaging abstraction layer 222. Additionally, messaging topology recommendation engine 214, trained using data from historical message metrics repository 206, generates one or more messaging topology recommendations (based at least in part on one or more anomalies predicted by messaging topology anomaly prediction engine 212 routed via messaging abstraction layer 222) and provides the same to messaging abstraction layer 222.

As also depicted in FIG. 2, messaging abstraction layer 222 then associates each of the message providers with a normal situation or an anomaly situation, based at least in part on the inputs provided by messaging topology anomaly prediction engine 212. Additionally, messaging abstraction layer 222 provides output to message consumer 221 which can include, for example, the recommendation(s) generated by messaging topology recommendation engine 214.

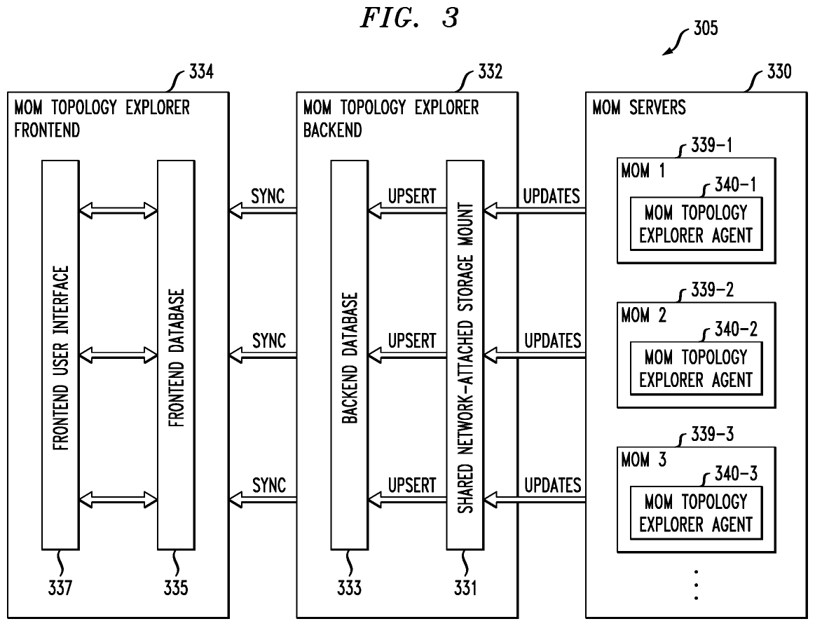

FIG. 3 shows example MOM topology explorer architecture in an illustrative embodiment. By way of illustration, FIG. 3 depicts example MOM topology explorer 305, which includes one or more MOM servers 330, within which MOM topology explorer agents 340-1, 340-2 and 340-3 (collectively referred to herein as MOM topology explorer agents 340), which connects MOM-specific protocols 339-1, 339-2 and 339-3, respectively, and fetches statistics in at least one native command format. Additionally, an update process can include, for example, at least one MOM topology explorer agent (e.g., 340) saving statistics captured from one or more MOM-specific protocols (e.g., 339) into at least one shared network-attached storage (NAS) mount 331. An upsert process can include, for example, the at least one shared NAS mount 331 updating and/or inserting MOM-specific statistical data into at least one backend database 333 (wherein the at least one shared NAS mount 331 and the at least one backend database 333 are part of MOM topology explorer backend component 332).

Further, a sync process can include, for example, the MOM topology explorer backend component 332 translating at least a portion of the MOM-specific statistical data into generic MOM terminology and forwarding such translated data into at least one frontend database 335. Relatedly, a MOM topology explorer frontend component 334, which includes the at least one frontend database 335, can also include at least one frontend UI 337 which, upon selecting (e.g., clicking on) a queue in the UI, fetches data through one or more APIs and translates at least a portion of such fetched data into at least one topology view with statistical details (e.g., hostnames, IP addresses, queue depth, age and transaction time, etc.).

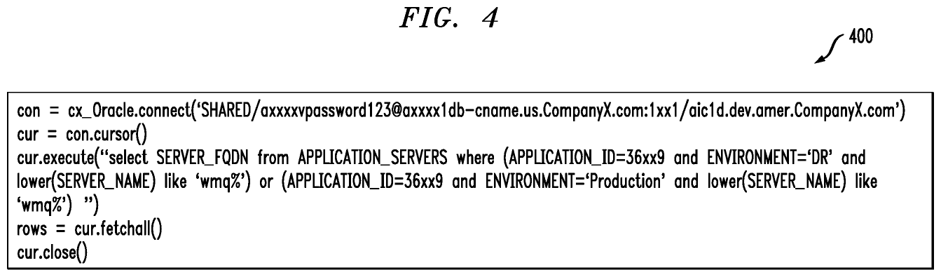

FIG. 4 shows example pseudocode for data acquisition in an illustrative embodiment. In this embodiment, example pseudocode 400 is executed by or under the control of at least one processing system and/or device. For example, the example pseudocode 400 may be viewed as comprising a portion of a software implementation of at least part of MOM topology explorer 105 of the FIG. 1 embodiment.

The example pseudocode 400 illustrates connecting to a database and/or configuration management database (CMDB) and collecting product information.

It is to be appreciated that this particular example pseudocode shows just one example implementation of data acquisition, and alternative implementations can be used in other embodiments.

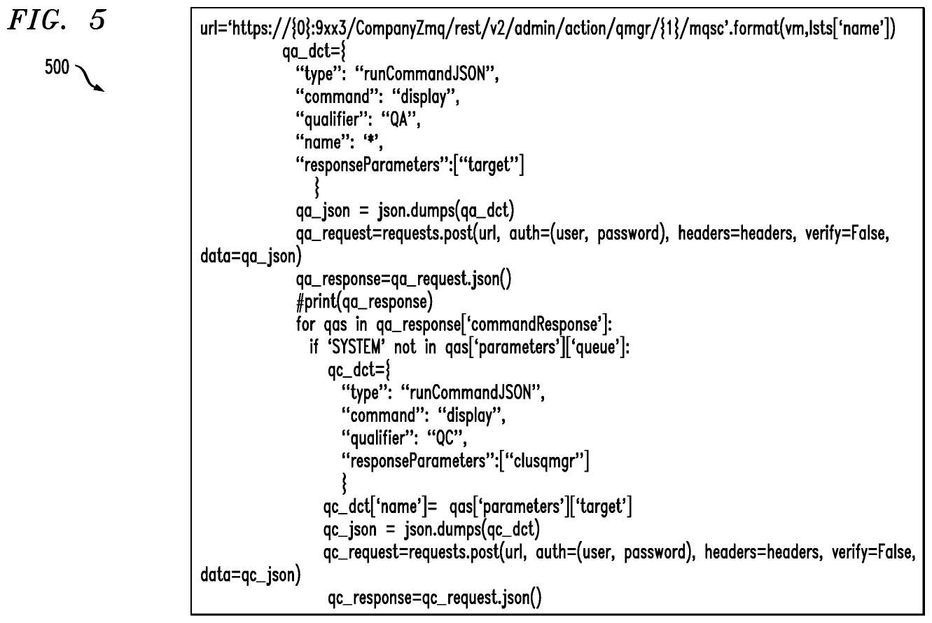

FIG. 5 shows example pseudocode for metadata classification in an illustrative embodiment. In this embodiment, example pseudocode 500 is executed by or under the control of at least one processing system and/or device. For example, the example pseudocode 500 may be viewed as comprising a portion of a software implementation of at least part of MOM topology explorer 105 of the FIG. 1 embodiment.

The example pseudocode 500 illustrates classification of message queue object metadata for source and target applications in a message-oriented middleware ecosystem. More specifically, example pseudocode 500 provides such a classification by accessing the host (e.g., url='https://{0}:9xx3/CompanyZmq/res) and passing the appropriate message-oriented middleware commands (e.g., display queue alias (QA) for the target host name, etc.).

It is to be appreciated that this particular example pseudocode shows just one example implementation of metadata classification, and alternative implementations can be used in other embodiments.

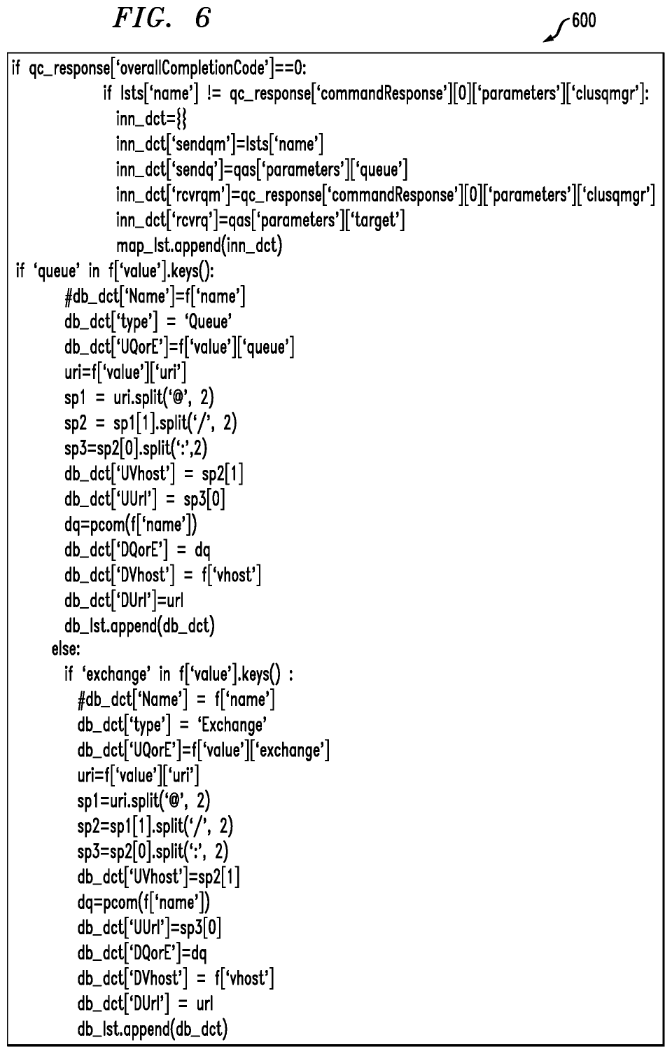

FIG. 6 shows example pseudocode for intelligent mapping techniques in an illustrative embodiment. In this embodiment, example pseudocode 600 is executed by or under the control of at least one processing system and/or device. For example, the example pseudocode 600 may be viewed as comprising a portion of a software implementation of at least part of MOM topology explorer 105 of the FIG. 1 embodiment.

The example pseudocode 600 illustrates intelligent mapping techniques which include a variety of conditional statements. It is to be appreciated that this particular example pseudocode shows just one example implementation of intelligent mapping techniques, and alternative implementations can be used in other embodiments.

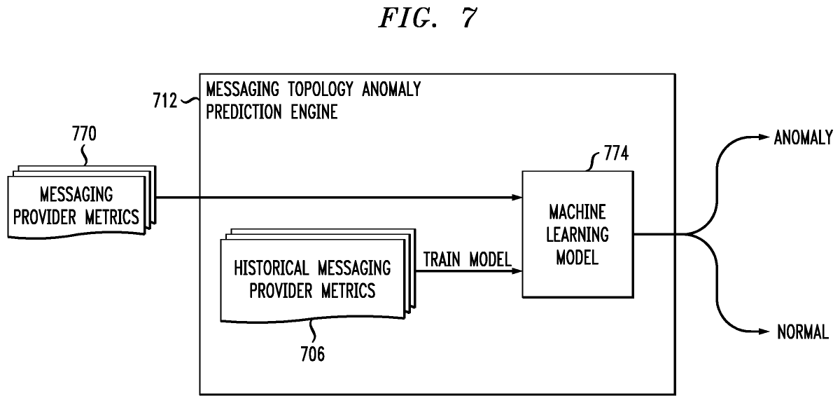

FIG. 7 shows example messaging topology anomaly prediction engine architecture in an illustrative embodiment. By way of illustration, FIG. 7 depicts messaging topology anomaly prediction engine 712, which includes machine learning model 774 (e.g., at least one isolation forest) which is trained using historical messaging provider metrics 706 (e.g., queue depth, consumers, producers, message age, transaction time, etc.). Also, FIG. 7 depicts machine learning model 774 processing messaging provider metrics 770 to generate a prediction associating at least a portion of the messaging provider metrics with at least one anomaly and/or normal conditions.

As detailed herein, the messaging topology anomaly prediction engine is responsible for predicting one or more upcoming anomalies and/or faults in at least one messaging topology. Such predictions can be generated by leveraging one or more anomaly detection techniques using one or more machine learning algorithms trained with historical messaging topology metrics (e.g., metrics captured by monitoring and/or logging systems). By way of example, monitoring systems can capture various metrics of message topology including queue depth, number of producers and consumers, messages ready, messages unacknowledged, etc., as well as server parameters including CPU, memory, and IO utilization, etc. Such metrics can be captured periodically in normal circumstances and/or during outages in messaging topology. Also, as many outages are built over a period of time, at least one anomaly detection algorithm, once trained with the historical metric data, can be implemented to predict if there is an upcoming outage for a given message topology.

In one or more embodiments, detecting anomalies can include implementing supervised learning techniques such as support vector machines (SVMs) and/or one or more artificial neural networks (ANNs). Such an embodiment includes using labeled data to indicate which matches represent normal conditions and which matches represent anomalous conditions. Such labeled data can be difficult to collect, particularly data representing anomalous conditions. Accordingly, at least one embodiment can include implementing at least one semi-supervised, statistics-based approach using one or more algorithms such as a one-class SVM and/or one or more auto-encoders trained with labeled data from normal conditions. In such an embodiment, significant deviations from such normal data are considered anomalies.

Additionally or alternatively, in one or more embodiments, detecting anomalies can include implementing unsupervised learning techniques using shallow learning and/or deep learning. By way of example, such an embodiment can include using one or more unsupervised learning methodologies for outlier detection of metrics from message topology data to predict an upcoming outage and/or other anomaly. An example embodiment includes using multivariate anomaly detection implemented using at least one isolation forest algorithm, which is does not require labeled training data.

Such an isolation forest algorithm can be scaled to handle large data volumes and high-dimensional problems with a large number of irrelevant attributes, while also having low linear time complexity and memory requirements. Additionally, such an isolation forest algorithm is effective in dealing with swamping and masking effects. Further, an isolation forest algorithm uses a decision tree ensemble method with at least one assumption that anomalies can be isolated with few conditions. Such an algorithm identifies anomalies among normal observations by setting-up one or more threshold values in at least one contamination parameter that can be applied for real-time predictions.

Also, such an isolation forest algorithm can isolate an anomaly by creating decision trees over random attributes. This random partitioning produces significantly shorter paths than other algorithms because fewer instances of anomalies result in smaller partitions, and distinguishable attribute values are more likely to be separated in early partitioning. Hence, when a forest (e.g., a group) of random trees collectively produces shorter path lengths for some particular points, then such points are increasingly likely to be anomalies. Accordingly, in such an embodiment, a larger number of splits is required to isolate a normal point, while an anomaly can be isolated by a smaller number of splits.

The number of splits determine the level at which the isolation occurred and/or will occur, and will be used to generate a corresponding anomaly score. The process can be repeated multiple times and the isolation level of each point can be noted accordingly. Once an iteration is complete, the anomaly score of each point suggests the likeliness of an anomaly, wherein, in at least one embodiment, the score is a function of the average level at which the point is isolated. The top points gathered on the basis of the score(s) are labeled as anomalies.

As further detailed herein, an example messaging topology anomaly prediction engine can be implemented using one or more libraries such as one or more python libraries, one or more scikit-learn libraries, one or more pandas libraries, and/or one or more numpy libraries.

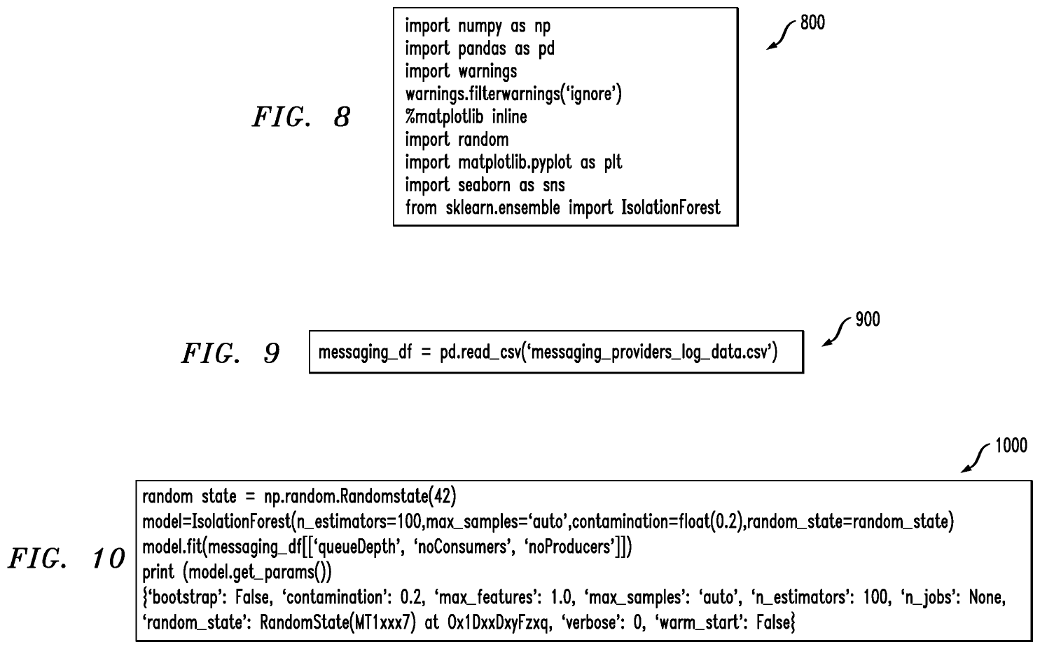

FIG. 8 shows example pseudocode for importing libraries in an illustrative embodiment. In this embodiment, example pseudocode 800 is executed by or under the control of at least one processing system and/or device. For example, the example pseudocode 800 may be viewed as comprising a portion of a software implementation of at least part of MOM topology explorer 105 of the FIG. 1 embodiment.

The example pseudocode 800 illustrates importing multiple libraries as well as an isolation forest model. It is to be appreciated that this particular example pseudocode shows just one example implementation of intelligent mapping techniques, and alternative implementations can be used in other embodiments.

FIG. 9 shows example pseudocode for loading messaging topology metrics data in an illustrative embodiment. In this embodiment, example pseudocode 900 is executed by or under the control of at least one processing system and/or device. For example, the example pseudocode 900 may be viewed as comprising a portion of a software implementation of at least part of MOM topology explorer 105 of the FIG. 1 embodiment.

The example pseudocode 900 illustrates loading historical messaging topology metrics data as well as server metrics into a pandas data frame for building training data.

It is to be appreciated that this particular example pseudocode shows just one example implementation of intelligent mapping techniques, and alternative implementations can be used in other embodiments.

FIG. 10 shows example pseudocode for instantiating an isolation forest model in an illustrative embodiment. In this embodiment, example pseudocode 1000 is executed by or under the control of at least one processing system and/or device. For example, the example pseudocode 1000 may be viewed as comprising a portion of a software implementation of at least part of MOM topology explorer 105 of the FIG. 1 embodiment.

The example pseudocode 1000 illustrates instantiating an isolation forest model from a ScikitLearn.ensemble package with hyperparameters such as contamination parameter, number of estimators, etc. The isolation forest model is then trained using the training data stored in the data frame (such as detailed in connection with FIG. 9). As depicted in example pseudocode 1000, the isolation forest model is trained using features of the dataset that include queue depth, number of consumers, and number of producers. In one or more embodiments, additional dimensions and/or features can be added in the data while training the model, as needed.

It is to be appreciated that this particular example pseudocode shows just one example implementation of intelligent mapping techniques, and alternative implementations can be used in other embodiments.

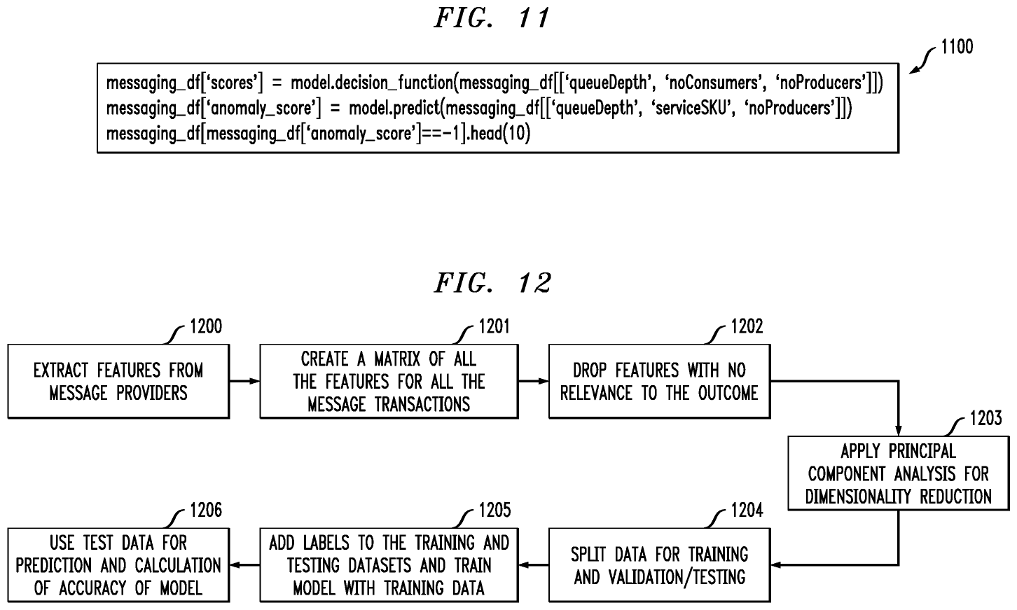

FIG. 11 shows example pseudocode for determining an anomaly score in an illustrative embodiment. In this embodiment, example pseudocode 1100 is executed by or under the control of at least one processing system and/or device. For example, the example pseudocode 1100 may be viewed as comprising a portion of a software implementation of at least part of MOM topology explorer 105 of the FIG. 1 embodiment.

The example pseudocode 1100 illustrates determining an anomaly score associated with a prediction generated by the model using a model.predict( ) function and processing metrics values. In at least one embodiment, a score of −1 indicates an anomaly and a score of 1 indicates a normal state prediction.

It is to be appreciated that this particular example pseudocode shows just one example implementation of intelligent mapping techniques, and alternative implementations can be used in other embodiments.

As also detailed herein, one or more embodiments include implementing a messaging topology recommendation engine, which is responsible for recommending one or more messaging topologies (e.g., the most appropriate alternate messaging topology), for example, when at least one given messaging topology is predicted to have an upcoming outage and/or other anomaly. Such an engine can be implemented, in at least one embodiment, by leveraging at least one machine learning-based classification algorithm and training such an algorithm using historical messaging topology metrics and/or other utilization data.

By way merely of illustration, when an outage of a messaging topology occurs, messages are typically routed to an alternate messaging topology (with an alternative option being to wait for the outage-impacted message topology to return and start processing the message, which is not a practical approach for many cases). Accordingly, one or more embodiments include using a machine learning-based approach which considers various factors including, for example, performance, scalability, message size, quality of service (exactly once, at least once, etc.), number of messages, producers, subscriber numbers, etc.

In at least one embodiment, for multiple messaging topologies, performance metrics and other features, as well as information pertaining to the type of topology, is collected from historical messaging and event transaction logs and audits. Feature extraction is carried out by processing at least a portion of such collected data and identifying one or more features that can influence the outcome and one or more features that do not influence the outcome (i.e., whether any anomaly (e.g., possible failure which affects system stability) is detected in connection with the topology). Relevancy can be computed, for example, by creating at least one heatmap and/or conducting exploratory data analysis such as, e.g., bi-variate plot analysis. In the feature extraction stage, features that are extracted from messaging data (e.g., messaging transactions) can include features related to message type, message size, message cost and/or time taken, memory utilization, CPU utilization, disk utilization, queue depth, quality of service, number of producers, number of consumers, etc.

Accordingly, in such an embodiment, unnecessary features can be removed from the data to reduce dimensionality and assist in the performance and accuracy of model training and prediction. As such, based at least in part on the feature extraction process, one or more machine learning models can be implemented to classify one or more messaging topologies for potential use in one or more recommendations.

FIG. 12 shows an example flow diagram for model training and testing in an illustrative embodiment. By way of illustration, step 1200 includes extracting features from message provider data, and step 1201 includes creating a matrix of the features for all relevant message transactions and/or content. Step 1202 includes dropping and/or removing features with no (or limited) relevance to the outcome of the prediction engine, and step 1203 includes applying principal component analysis (PCA) techniques to the remaining data to reduce dimensionality. Step 1204 includes splitting the remaining data into training and testing and/or validation datasets, step 1205 includes adding labels to the training and testing data, and training the prediction model using the labeled training data. Additionally, step 1206 includes using the labeled testing data to generate one or more predictions and calculate one or more accuracy values attributed to the model.

Additionally, at least one embodiment includes leveraging one or more shallow learning techniques to build one or more classification models for prediction(s). Shallow learning techniques can be appropriate, for example, when there is lower data dimensionality and a less efforts are expected for training the model. As a shallow learning option, one or more embodiments include using at least one ensemble bagging technique with one or more random forest algorithms utilized as a multi-class classification approach for predicting the class(es) of messaging topologies to be recommended as alternate(s) to at least one given messaging topology.

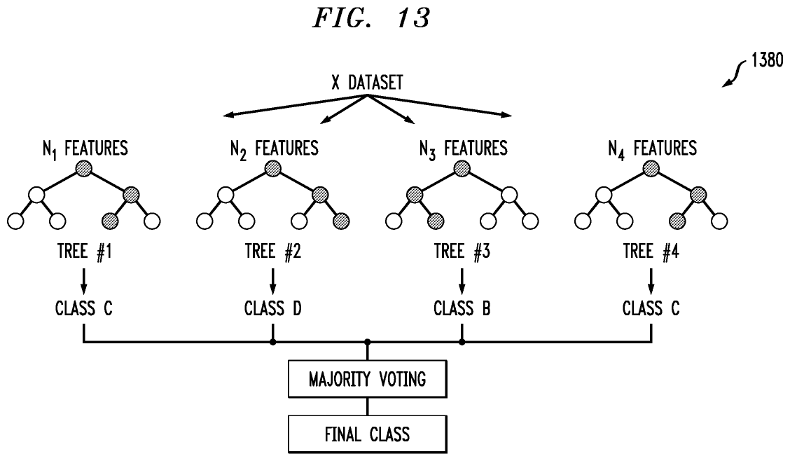

FIG. 13 shows an example random forest classifier structure 1380 in an illustrative embodiment. By way of illustration, FIG. 13 depicts a random forest classifier structure 1380, chosen and/or implemented for prediction and recommendation tasks because of its efficiency and accuracy in connection with processing large volumes of data, uses bagging (also referred to herein as bootstrap aggregating) techniques to generate predictions, including using multiple classifiers (e.g., in parallel), each trained on different data samples and different features. Such techniques can reduce the variance and the bias stemming from using a single classifier, and the final classification is achieved by aggregating the predictions that were made by the different classifiers.

As noted above, a random forest can be composed of multiple decision trees, and each decision tree is constructed using different features and different data samples which reduces bias and variance. In the training process, the decision trees are constructed using training data. In the testing process, each new prediction that needs to be made runs through the different decision trees, with each decision tree yielding a score and the final prediction being determined by voting (e.g., which class received the majority of votes).

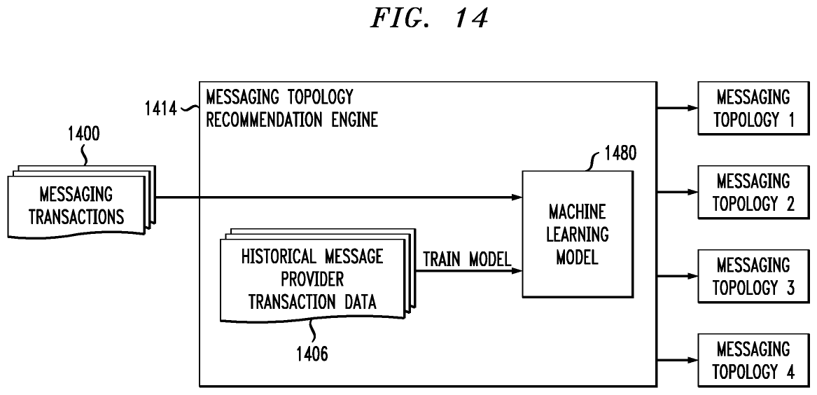

FIG. 14 shows messaging topology recommendation engine architecture in an illustrative embodiment. By way of illustration, FIG. 14 depicts messaging topology recommendation engine 1414, which includes machine learning model 1480 (e.g., at least one random forest classifier) which is trained using historical messaging provider transaction data 1406 (e.g., queue depth, consumer information, producer information, message age, transaction time, process failure, error code, etc.). Also, FIG. 14 depicts machine learning model 1480 processing messaging transactions 1400 to generate a recommendation associating with at least one of messaging topology 1, messaging topology 2, messaging topology 3, and messaging topology 4.

In one or more embodiments, at least one random forest classifier uses multinomial and/or multi-class classification, whereby the results of a given classification can be one of multiple types of classes. By way merely of example, each class can be associated with a storage class or tier, such that there are potentially multiple classes, and the model predicts one of the classes (e.g., a messaging topology) in connection with a confidence score. The multiple independent variables (i.e., X values) can include, for example, processing type, queue depth, quality of service, cost and/or latency, CPU utilization, memory utilization, etc., whereas the target variable (i.e., the Y value) is the messaging topology predicted and/or recommended by the model.

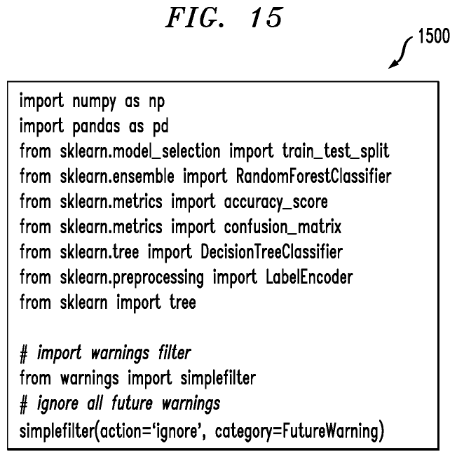

This engine can be built using scikit-learn libraries with Python programming language. The sample code for a POC to achieve multi-class classification using Random Forest to predict optimized storage tier class for the database is shown in FIG. 15 through FIG. 17.

FIG. 15 shows example pseudocode for importing libraries and one or more filters in an illustrative embodiment. In this embodiment, example pseudocode 1500 is executed by or under the control of at least one processing system and/or device. For example, the example pseudocode 1500 may be viewed as comprising a portion of a software implementation of at least part of MOM topology explorer 105 of the FIG. 1 embodiment.

The example pseudocode 1500 illustrates importing necessary libraries (e.g., scikit-learn, pandas, numpy, etc.) and at least one filter. It is to be appreciated that this particular example pseudocode shows just one example implementation of intelligent mapping techniques, and alternative implementations can be used in other embodiments.

FIG. 16 shows example pseudocode for reading a data file and splitting datasets in an illustrative embodiment. In this embodiment, example pseudocode 1600 is executed by or under the control of at least one processing system and/or device. For example, the example pseudocode 1600 may be viewed as comprising a portion of a software implementation of at least part of MOM topology explorer 105 of the FIG. 1 embodiment.

The example pseudocode 1600 illustrates reading a database transaction history file to create a training data frame. In example pseudocode 1600, the data are created as a comma-separated value (CSV) file, and the data are read to a Pandas data frame. Once dimensions are reduced using PCA, the data are separated into independent variables (X) and the dependent variable (Y) based on the position of the column in the data frame. The categorical data in both the independent variables and the dependent variable are encoded using LabelEncoder, then the data are split into training and testing datasets using a train_test_split function of a sklearn library. By way of example, in one or more embodiments, the training dataset will contain approximately 70% of the observations while the testing dataset will contain approximately 30% of the observations.

It is to be appreciated that this particular example pseudocode shows just one example implementation of intelligent mapping techniques, and alternative implementations can be used in other embodiments.

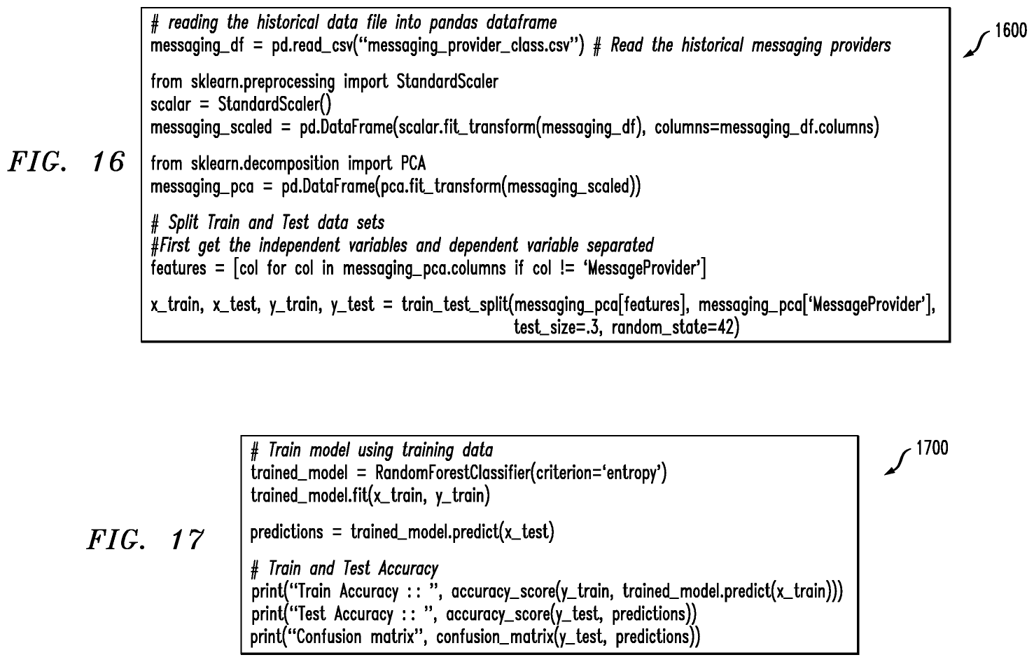

FIG. 17 shows example pseudocode for training and testing a random forest classifier in an illustrative embodiment. In this embodiment, example pseudocode 1700 is executed by or under the control of at least one processing system and/or device. For example, the example pseudocode 1700 may be viewed as comprising a portion of a software implementation of at least part of MOM topology explorer 105 of the FIG. 1 embodiment.

The example pseudocode 1700 illustrates creating a random forest classifier model using a sklearn library with entropy as the criterion hyperparameter. The model is trained using the training dataset(s) in connection with the independent variables (X_train) and the target variable (y_train). Once trained, the model is asked to generate a prediction by passing the testing dataset(s) of the independent variable (X_test). As also depicted in example pseudocode 1700, the prediction(s), accuracy, and confusion matrix are printed, hyperparameters of the model can be tuned to improve the accuracy of the predictions.

It is to be appreciated that this particular example pseudocode shows just one example implementation of intelligent mapping techniques, and alternative implementations can be used in other embodiments.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations and/or predictions. For example, one or more of the models described herein may be trained to generate recommendations and/or predictions based on message topology data collected from various log data and/or audit data sources, and such recommendations and/or predictions can be used to initiate one or more automated actions (e.g., automatically initiating a transition to one or more alternate messaging topologies).

FIG. 18 is a flow diagram of a process for implementing topology explorers for message-oriented middleware using machine learning techniques in an illustrative embodiment. It is to be understood that this particular process is only an example, and additional or alternative processes can be carried out in other embodiments.

In this embodiment, the process includes steps 1800 through 1806. These steps are assumed to be performed by MOM topology explorer 105 utilizing elements 112, 114 and 116.

Step 1800 includes obtaining data pertaining to at least one messaging topology associated with at least one message-oriented middleware (e.g., from any vendor).

Step 1802 includes predicting one or more anomalies associated with the at least one messaging topology by processing at least a portion of the obtained data using a first set of one or more machine learning techniques. In at least one embodiment, predicting one or more anomalies includes processing the at least a portion of the obtained data using one or more unsupervised learning techniques. In such an embodiment, processing the at least a portion of the obtained data using one or more unsupervised learning techniques can include processing the at least a portion of the obtained data using at least one of using at least one isolation forest algorithm.

Additionally or alternatively, in at least one embodiment, predicting one or more anomalies includes processing the at least a portion of the obtained data using one or more supervised learning techniques. In such an embodiment, processing the at least a portion of the obtained data using one or more supervised learning techniques can include processing the at least a portion of the obtained data using at least one of one or more SVMs and one or more ANNs.

Step 1804 includes recommending one or more alternate messaging topologies associated with the at least one message-oriented middleware by processing at least a portion of the one or more predicted anomalies and at least a portion of the obtained data using a second set of one or more machine learning techniques. In one or more embodiments, recommending one or more alternate messaging topologies includes processing at least a portion of the one or more predicted anomalies and at least a portion of the obtained data using at least one machine learning-based classification algorithm. In such an embodiment, processing at least a portion of the one or more predicted anomalies and at least a portion of the obtained data using at least one machine learning-based classification algorithm can include processing at least a portion of the one or more predicted anomalies and at least a portion of the obtained data using at least one random forest classifier, wherein using the at least one random forest classifier includes implementing one or more bootstrap aggregating techniques in connection with multiple individual classifiers each trained on different data.

Step 1806 includes performing one or more automated actions based at least in part on one or more of the one or more predicted anomalies and the one or more recommended alternate messaging topologies. In at least one embodiment, performing one or more automated actions includes automatically routing at least one message to at least one of the one or more recommended alternate messaging topologies upon occurrence of at least one event related to the one or more predicted anomalies. Additionally or alternatively, performing one or more automated actions can include automatically training at least a portion of the first set of one or more machine learning techniques using feedback related to the one or more predicted anomalies and/or automatically training at least a portion of the second set of one or more machine learning techniques using feedback related to the one or more recommended alternate messaging topologies.

Accordingly, the particular processing operations and other functionality described in conjunction with the flow diagram of FIG. 18 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically implement topology explorers for message-oriented middleware using machine learning techniques. These and other embodiments can effectively overcome problems associated with resource-intensive outages and delays.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

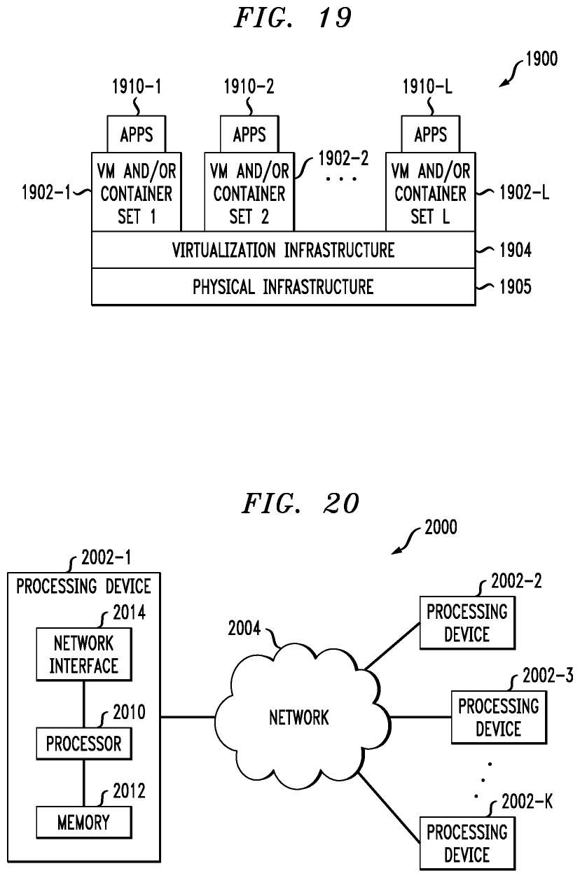

Illustrative embodiments of processing platforms will now be described in greater detail with reference to FIGS. 19 and 20. Although described in the context of system 100, these platforms may also be used to implement at least portions of other information processing systems in other embodiments.

FIG. 19 shows an example processing platform comprising cloud infrastructure 1900. The cloud infrastructure 1900 comprises a combination of physical and virtual processing resources that are utilized to implement at least a portion of the information processing system 100. The cloud infrastructure 1900 comprises multiple virtual machines (VMs) and/or container sets 1902-1, 1902-2, . . . 1902-L implemented using virtualization infrastructure 1904. The virtualization infrastructure 1904 runs on physical infrastructure 1905, and illustratively comprises one or more hypervisors and/or operating system level virtualization infrastructure. The operating system level virtualization infrastructure illustratively comprises kernel control groups of a Linux operating system or other type of operating system.

The cloud infrastructure 1900 further comprises sets of applications 1910-1, 1910-2, . . . , 1910-L running on respective ones of the VMs/container sets 1902-1, 1902-2, . . . 1902-L under the control of the virtualization infrastructure 1904. The VMs/container sets 1902 comprise respective VMs, respective sets of one or more containers, or respective sets of one or more containers running in VMs. In some implementations of the FIG. 19 embodiment, the VMs/container sets 1902 comprise respective VMs implemented using virtualization infrastructure 1904 that comprises at least one hypervisor.

A hypervisor platform may be used to implement a hypervisor within the virtualization infrastructure 1904, wherein the hypervisor platform has an associated virtual infrastructure management system. The underlying physical machines comprise one or more information processing platforms that include one or more storage systems.

In other implementations of the FIG. 19 embodiment, the VMs/container sets 1902 comprise respective containers implemented using virtualization infrastructure 1904 that provides operating system level virtualization functionality, such as support for Docker containers running on bare metal hosts, or Docker containers running on VMs. The containers are illustratively implemented using respective kernel control groups of the operating system. As is apparent from the above, one or more of the processing modules or other components of system 100 may each run on a computer, server, storage device or other processing platform element. A given such element is viewed as an example of what is more generally referred to herein as a “processing device.” The cloud infrastructure 1900 shown in FIG. 19 may represent at least a portion of one processing platform. Another example of such a processing platform is processing platform 2000 shown in FIG. 20.

The processing platform 2000 in this embodiment comprises a portion of system 100 and includes a plurality of processing devices, denoted 2002-1, 2002-2, 2002-3, . . . 2002-K, which communicate with one another over a network 2004.

The network 2004 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 2002-1 in the processing platform 2000 comprises a processor 2010 coupled to a memory 2012.

The processor 2010 comprises a microprocessor, a CPU, a GPU, a TPU, a microcontroller, an ASIC, a FPGA or other type of processing circuitry, as well as portions or combinations of such circuitry elements.

The memory 2012 comprises random access memory (RAM), read-only memory (ROM) or other types of memory, in any combination. The memory 2012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 2002-1 is network interface circuitry 2014, which is used to interface the processing device with the network 2004 and other system components, and may comprise conventional transceivers.

The other processing devices 2002 of the processing platform 2000 are assumed to be configured in a manner similar to that shown for processing device 2002-1 in the figure.

Again, the particular processing platform 2000 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining data pertaining to at least one messaging topology associated with at least one message-oriented middleware;
predicting one or more anomalies associated with the at least one messaging topology by processing at least a portion of the obtained data using a first set of one or more machine learning techniques;
recommending one or more alternate messaging topologies associated with the at least one message-oriented middleware by processing at least a portion of the one or more predicted anomalies and at least a portion of the obtained data using a second set of one or more machine learning techniques; and
performing one or more automated actions based at least in part on one or more of the one or more predicted anomalies and the one or more recommended alternate messaging topologies;
wherein the method is performed by at least one processing device comprising a processor coupled to a memory.

2. The computer-implemented method of claim 1, wherein predicting one or more anomalies comprises processing the at least a portion of the obtained data using one or more unsupervised learning techniques.

3. The computer-implemented method of claim 2, wherein processing the at least a portion of the obtained data using one or more unsupervised learning techniques comprises processing the at least a portion of the obtained data using at least one of using at least one isolation forest algorithm.

4. The computer-implemented method of claim 1, wherein predicting one or more anomalies comprises processing the at least a portion of the obtained data using one or more supervised learning techniques.

5. The computer-implemented method of claim 4, wherein processing the at least a portion of the obtained data using one or more supervised learning techniques comprises processing the at least a portion of the obtained data using at least one of one or more support vector machines and one or more artificial neural networks.

6. The computer-implemented method of claim 1, wherein recommending one or more alternate messaging topologies comprises processing at least a portion of the one or more predicted anomalies and at least a portion of the obtained data using at least one machine learning-based classification algorithm.

7. The computer-implemented method of claim 6, wherein processing at least a portion of the one or more predicted anomalies and at least a portion of the obtained data using at least one machine learning-based classification algorithm comprises processing at least a portion of the one or more predicted anomalies and at least a portion of the obtained data using at least one random forest classifier, wherein using the at least one random forest classifier comprises implementing one or more bootstrap aggregating techniques in connection with multiple individual classifiers each trained on different data.

8. The computer-implemented method of claim 1, wherein performing one or more automated actions comprises automatically routing at least one message to at least one of the one or more recommended alternate messaging topologies upon occurrence of at least one event related to the one or more predicted anomalies.

9. The computer-implemented method of claim 1, wherein performing one or more automated actions comprises automatically training at least a portion of the first set of one or more machine learning techniques using feedback related to the one or more predicted anomalies.

10. The computer-implemented method of claim 1, wherein performing one or more automated actions comprises automatically training at least a portion of the second set of one or more machine learning techniques using feedback related to the one or more recommended alternate messaging topologies.

11. A non-transitory processor-readable storage medium having stored therein program code of one or more software programs, wherein the program code when executed by at least one processing device causes the at least one processing device:
to obtain data pertaining to at least one messaging topology associated with at least one message-oriented middleware;
to predict one or more anomalies associated with the at least one messaging topology by processing at least a portion of the obtained data using a first set of one or more machine learning techniques;
to recommend one or more alternate messaging topologies associated with the at least one message-oriented middleware by processing at least a portion of the one or more predicted anomalies and at least a portion of the obtained data using a second set of one or more machine learning techniques; and
to perform one or more automated actions based at least in part on one or more of the one or more predicted anomalies and the one or more recommended alternate messaging topologies.

12. The non-transitory processor-readable storage medium of claim 11, wherein predicting one or more anomalies comprises processing the at least a portion of the obtained data using one or more unsupervised learning techniques.

13. The non-transitory processor-readable storage medium of claim 11, wherein predicting one or more anomalies comprises processing the at least a portion of the obtained data using one or more supervised learning techniques.

14. The non-transitory processor-readable storage medium of claim 11, wherein recommending one or more alternate messaging topologies comprises processing at least a portion of the one or more predicted anomalies and at least a portion of the obtained data using at least one machine learning-based classification algorithm.

15. The non-transitory processor-readable storage medium of claim 11, wherein performing one or more automated actions comprises automatically routing at least one message to at least one of the one or more recommended alternate messaging topologies upon occurrence of at least one event related to the one or more predicted anomalies. 16 An apparatus comprising:
at least one processing device comprising a processor coupled to a memory;
the at least one processing device being configured:
to obtain data pertaining to at least one messaging topology associated with at least one message-oriented middleware;
to predict one or more anomalies associated with the at least one messaging topology by processing at least a portion of the obtained data using a first set of one or more machine learning techniques;
to recommend one or more alternate messaging topologies associated with the at least one message-oriented middleware by processing at least a portion of the one or more predicted anomalies and at least a portion of the obtained data using a second set of one or more machine learning techniques; and
to perform one or more automated actions based at least in part on one or more of the one or more predicted anomalies and the one or more recommended alternate messaging topologies.

17. The apparatus of claim 16, wherein predicting one or more anomalies comprises processing the at least a portion of the obtained data using one or more unsupervised learning techniques.

18. The apparatus of claim 16, wherein predicting one or more anomalies comprises processing the at least a portion of the obtained data using one or more supervised learning techniques.

19. The apparatus of claim 16, wherein recommending one or more alternate messaging topologies comprises processing at least a portion of the one or more predicted anomalies and at least a portion of the obtained data using at least one machine learning-based classification algorithm.

20. The apparatus of claim 16, wherein performing one or more automated actions comprises automatically routing at least one message to at least one of the one or more recommended alternate messaging topologies upon occurrence of at least one event related to the one or more predicted anomalies.
